(19) United States
(12) Patent Application Publication
(10) Pub. No.: US 2005/0170042 A1
(43) Pub. Date: Aug. 4, 2005

(54) Liquid mixture for producing a substantially gluten-free beer in conformity with Jewish Orthodox law

(76) Inventors: Daniel R. Scott, Middletown, NY (US); Egon Linzenberg, Monsey, NY (US); Joseph Sheldon Blech, Monsey, NY (US)

Correspondence Address: KALIKO & YEAGER, L.L.C., 500 NORTH FRANKLIN TURNPIKE, RAMSEY, NJ, 07446, US

(21) Appl. No.: 10/917,057

(22) Filed: Aug. 12, 2004

Related U.S. Application Data
(60) Provisional application No. 60/508,783, filed on Feb. 2, 2004.

(51) Int. Cl. C12C 11/00

(52) U.S. Cl. 426/11

(57) ABSTRACT

A liquid mixture for producing a substantially gluten-free beer that conforms to Jewish Orthodox law is provided. The liquid mixture may include a base of filtered water, at least two sugars, wherein the two sugars are honey and molasses. The liquid mixture may also include a bittering agent, wherein the bittering agent is obtained from a plurality of hops, and wherein the hops are obtained from the group consisting of Centennial hops, Perle hops, Saaz hops, and Hallertauer hops. The liquid mixture may further include a protein coagulant, a yeast nutrient, and a plurality of yeast cells.

This application claims priority from U.S. Provisional Application 60/508,783 filed Feb. 2, 2004.

### BACKGROUND OF THE INVENTION

The present invention relates to a method and a mix for the preparation of beverage products. More particularly, the present invention relates to a method and mix for the preparation of gluten-free and substantially gluten-free beer produced in the substantial absence of wheat, barley, and malt.

As is known, beer is commonly made with wheat, barley, or malt products. All of these grains contain gluten, which contributes to the typical texture and flavor of beer.

There are, however, circumstances in which wheat, barley, or malt are not readily available or cannot be used for the production of beer. For example, a segment of the population suffers from dietary wheat intolerance that includes disturbances such as classical celiac disease and related, less well-defined wheat intolerances and allergies all expressed by gastrointestinal disturbances that make wheat-based products unacceptable for use.

Furthermore, in developing countries wheat, barley, and malt are only sparsely grown, often because climate, agronomical practices, and/or soil are less suitable for its cultivation. If people in these areas wish to produce beer, they will need to import wheat, barley, or malt and pay for it using foreign currency. This is an adverse economic factor for nearly every developing country.

Finally, Jewish dietary laws strictly prohibit the common use of wheat and its leavened products during the Jewish holiday of Passover. During Passover, Jewish dietary laws prohibit Jews from consuming, owning, or deriving any benefit from grains (i.e., wheat, rye, oats, barley, and spelt) that have been allowed to ferment using leavened products or the leavening process, as described below.

Leavening is the process by which gasses are created and trapped in dough so that it rises. These gasses can be created by either chemical or biological reactions. Chemical leavens, such as baking soda (i.e., sodium bicarbonate), work by reacting with acids present in the dough to produce carbon dioxide and are typically used in crackers and cakes.

Yeast is also a biological leaven. The yeast cells consume sugar in dough and secrete an enzyme called zymase. When baking bread, the zymase converts the left over sugar in the bread into carbon dioxide (and a small amount of alcohol), a process called fermentation that in turn causes the bread to rise (i.e., leavening).

Yeast cells are abundant in nature, and, by merely leaving dough or a sugary solution open to the air, yeast from the air will grow and react with dough or sugary solution. However, Jewish law does not prohibit the entire use of yeast cells. The laws governing Passover do allow the use of yeast cells that do not come from a leavened product or process. For example, natural yeast cells used in the production of kosher wine may be consumed during Passover.

When a sugary substance is fermented in the absence of oxygen (anaerobically), the fermentation tends to create more alcohol than that of the leavening of a bread product. This is the process by which all alcoholic drinks are produced. For example, when squeezing fruit, the yeast cells found naturally on the surface of the fruit react with the juice, converting the fruit sugar into alcohol and producing wine. This type of fermentation typically produces an alcohol concentration of approximately 15%. However, the preferred alcohol content of beer is typically between four and six percent alcohol by volume.

Today, the production of beer in the western world primarily includes the incorporation of barley, wheat, and malt into the production process. As mentioned above, the incorporation of these grains in the beer making process introduces gluten into the beer, and the incorporation of any of these grains is strictly forbidden during Passover under Orthodox Jewish law. For example, barley may be soaked in water to malt (i.e., allow the barley germ to produce enzymes that convert the barley starch into sugar), after which the yeast cells ferment sugar to create alcohol. Another known process is the production of beer using Fruit (e.g., figs, dates, berries, etc.).

Fruit beer, however, is nothing more than fruit wine, where the natural sugar in the fruit is fermented with yeast to produce alcohol, which again has the potential (depending upon the origin of the yeast, as described above) of being prohibited during Passover. Regardless of its base material, however, beer made from fermented sugar would tend to be sweet, not the bitter and astringent beer that seems to be the flavor preferred in many cultures. To address this challenge, beer makers have historically added a variety of flavorings to their beer, such as wild rosemary, coriander, ginger, anise seed, juniper berries, and wood bark. The most popular additive, however, is the flower from a vine called hops, which serves to give both a bitter bite to the beer as well as to help preserve it. It also has mild sedative properties, and thus complements the effects of the alcohol. Today, the hops flower is added directly into the beer vats, or an extract of the rosin of the hops (rich in alpha acids) is used as a flavoring.

Thus, in consideration for each of the above circumstances it would be desirable to develop a liquid mixture for producing a beer made from products that are substantially gluten-free.

It would also be desirable to develop a liquid mixture for producing a beer that may be consumed by Orthodox Jews during the Jewish holiday of Passover.

### SUMMARY OF THE INVENTION

It is an object of the present invention to provide a liquid mixture for producing beer made from products that are substantially gluten-free.

It is also an object of the present invention to provide a liquid mixture for producing a beer that may be consumed by Orthodox Jews during the Jewish holiday of Passover.

In accordance with the present invention, a liquid mixture for producing a substantially gluten-free beer that conforms to Jewish Orthodox law is provided. A liquid mixture for producing a substantially gluten-free beer that conforms to Jewish Orthodox law may include a base of filtered water, at least two sugars, wherein the two sugars are honey and molasses. The mixture may also include a bittering agent, wherein the bittering agent is obtained from a plurality of hops, and wherein the hops are obtained from the group consisting of Centennial hops, Perle hops, Saaz hops, and Hallertauer hops. The liquid mixture may further include a protein coagulant, a yeast nutrient, and a plurality of yeast cells.

The above and other objects, features, and advantages of the present invention will become apparent upon consideration of the following detailed description.

### DETAILED DESCRIPTION OF THE PREFERRED EMBODIMENTS

According to the present invention it has now been discovered that a liquid, water-based mixture for producing beer can be produced in the substantial absence of wheat, barley, and/or malt products. More specifically, the present invention provides a liquid mixture for the preparation of a beer product comprising honey, molasses, hops, and yeast.

Preferably the honey used in the liquid mixture of the present invention will be SUE BEE Light Amber Honey. However, those skilled in the art will appreciate that other types of honey may be used to practice the present invention. From a technical standpoint, virtually any type of honey can be used in the brewing process. For example, the honey used in the present invention may vary in color ranging from white to dark amber and the tastes from mild to bold. Each type of honey contributes something different in terms of end-product color, aroma, rounding effect, and flavor. It should also be noted that variations in the sugar content of the honey used might produce variations in the alcohol content of the final product; however, the preferable alcohol content of the final product is be between four and six percent by volume.

The molasses used in the liquid mix of the present invention is preferably certified kosher molasses. Molasses may be used in the present invention to add complexity, flavor, and aroma to the liquid mix. Moreover, the use of molasses may be used as a nutrient for the yeast during the fermentation process.

The hops used in the liquid mixture of the present invention is preferably selected from the group consisting of Centennial, Perle, Saaz, and Hallertauer. Preferably, the hops set forth in Chart “A”, immediately below, may be used to produce the desired amount and combination of hops in the liquid mixture of the present invention. Nevertheless, those skilled in the art will appreciate that other combinations of hops may be used to practice the present invention. Such combinations may be derived using the formula International Bittering Unit (IBU) equals weight of the hops in ounces multiplied by the Alpha Acid of the Hops in Percent multiplied by the utilization (a full boil for 60 minutes) multiplied by the volume (gallons) multiplied by 1.34.

CHART A

| IBU | Weight | Type of Hop | Alpha Acid | Brewing Time (Min) |
|---|---|---|---|---|
| 2.5 | 8 | Centennial | 7.4 | 60 |
| 2.5 | 8 | Perle | 7.2 | 60 |
| 2.5 | 16 | Saaz | 3.8 | 60 |
| 2.3 | 16 | Hallertaur | 3.3 | 60 |
| .8 | 16 | Hallertaur | 3.3 | 20 |
| .8 | 16 | Saaz | 3.8 | 20 |
| — | 8 | Hallertaur | — | 10-15 (Non-Brew Time) |
| — | 8 | Saaz | — | 10-15 (Non-Brew Time) |

The yeast used in the liquid mix of the present invention is preferably SafAle Dried Ale Yeast S-04. SafAle S-04 is a well-known, bottom-fermenting ale yeast strain. This is a yeast that is selected for its fast fermentation characteristics and its ability to form compact sediment at the end of the fermentation process, helping beer clarity. This strain is especially well adapted to closed fermentation vessels. It should also be noted that other types of yeast with similar properties to that of the SafAle S-04 yeast might be used to practice the present invention.

The present invention may also include a yeast nutrient to provide for and promote yeast growth during the anaerobic phase of the yeast's life cycle. For example, one type of yeast nutrient that may be used to practice the present invention may be Yeast-X.

The present invention may also include a protein coagulant. The protein coagulant may be added to the liquid mixture of the present invention to bind free-floating proteins that may exist in mixture. When the protein coagulant binds to the free-floating proteins, the combination of the proteins and the coagulant becomes denser than the liquid mixture and such coagulant-protein combinations sink to the bottom of the liquid mixture facilitating their removal from the mixture. Thus, the protein coagulant acts as a clarifying agent producing a clear and more brilliant final product. For example, one type of protein coagulant that may be used to practice the present invention may be Irish Moss or Carrageen (Also known as Irish Carraigeen or moss of the rock).

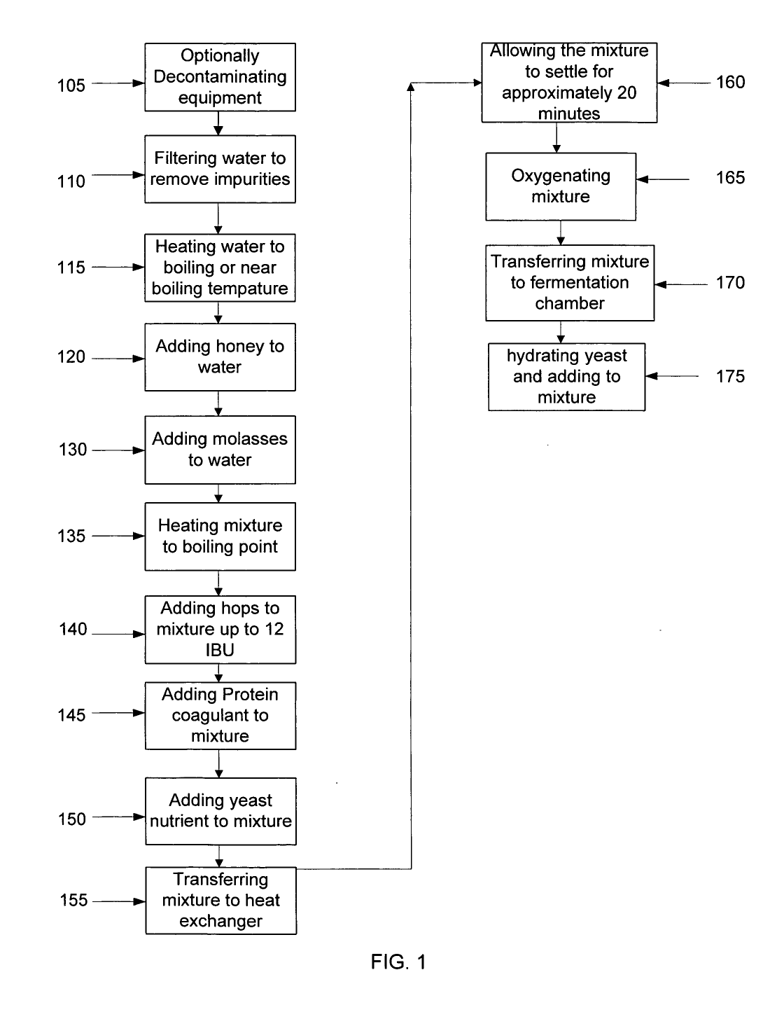

As shown in FIG. 1, the production of beer using the liquid mixture of the present invention may be produced in the following manner. At step 110, water (H₂O) may be filtered to remove impurities. For example, water at step 110 may be filtered using a charcoal filtering process. Next at step 115, the filtered water at step 110 may be heated to its boiling point or a near boiling point temperature. At step 120, honey may be added to the heated water. At step 130, molasses may be added to the heated water/honey mixture. At step 135, the water, honey, and molasses mixture is heated to a boil, and the mixture is kept at its boiling point for approximately one hour. At step 140 and during the one hour boil in step 135, hops may be added into the water, honey, and molasses mixture, as defined by Chart “A” set forth above. At step 145 and during the boil in step 135, a protein coagulant may be added to the water, honey, molasses, and hops mixture. At step 150 and during the boil in step 135, a yeast nutrient may be added to the water, honey, molasses, and hops mixture. At step 155, the liquid mixture in step 150 may be allowed to settle for approximately 20 minutes in order to allow sediments and coagulated proteins to settle out of the liquid mixture. At step 160, the heated mixture in step 155 may be passed through a heat exchanger to reduce the temperature of the liquid from a boiling or near boiling temperature to a preferred temperature of between 70 and 80 degrees Fahrenheit. At step 165, the cooled liquid mixture may then be sufficiently oxygenated to provide a suitable environment for the yeast in the liquid mixture to multiply during their aerobic life cycle. At step 170 the cooled, oxygenated liquid mixture may be transferred into a fermenting chamber/storage device. At step 175, yeast may be hydrated and added to the liquid mixture. It should be noted that the hydrated yeast may be added to the liquid mixture before or after the liquid is transferred to the fermenting chamber/storage device.

It should be noted that the above-described method might include step 105. Step 105 may include a kosher-for-Passover decontamination process to ensure that any leavened grain product that has previously come in contact with any equipment used in the above-described method is removed and/or neutralized. The decontamination process may include using steam or boiling water on all associated equipment to remove any leavened grain product on the equipment.

The following examples illustrate mixtures for the preparation of 15 barrels of beer. Example one shows an illustrative mixture for the preparation of 15 barrels of beer at 4% alcohol by volume.

### EXAMPLE 1

Preparation of 15 Barrels (bbl) of
Gluten-Free Beer
at 4% Alcohol By Volume (ABV)

| | | |
|---|---|---|
| Honey | 380 | lbs |
| Molasses | .8 | gallons |
| Hops | up to 12 | IBU |
| Yeast | 500 | grams |

Example two shows an illustrative mixture for the preparation of 15 barrels of beer at 5% alcohol by volume.

### EXAMPLE 2

Preparation of 15 Barrels (bbl) of
Gluten-Free Beer
at 5% Alcohol By Volume (ABV)

| | | |
|---|---|---|
| Honey | 480 | lbs |
| Molasses | .1 | gallons |
| Hops | up to 12 | IBU |
| Yeast | 500 | grams |

Example one shows an illustrative mixture for the preparation of 15 barrels of beer at 6% alcohol by volume.

### EXAMPLE 3

Preparation of 15 Barrels (bbl) of
Gluten-Free Beer
at 6% Alcohol By Volume (ABV)

| | | |
|---|---|---|
| Honey | 580 | lbs |
| Molasses | 1.2 | gallons |
| Hops | up to 12 | IBU |
| Yeast | 500 | grams |

Thus, a liquid for producing a substantially gluten-free beer in conformity with Jewish Orthodox law is provided. Persons skilled in the art will appreciate that the described embodiments are presented for the purpose of illustration rather than limitation and that the present invention is limited only by the claims that follow.

1. A liquid mixture for producing a substantially gluten-free beer in conformity with Jewish Orthodox Law comprising:
a base, wherein the base is filtered water;
at least two sugars, wherein the two sugars are honey and molasses;
a bittering agent, wherein the bittering agent is obtained from a plurality of hops, and wherein the hops are obtained from the group consisting of Centennial hops, Perle hops, Saaz hops, and Hallertauer hops;
a protein coagulant;
a yeast nutrient;
a plurality of yeast cells; and
Wherein the base, the sugars, the bittering agent, the protein coagulant, the yeast nutrient, and the plurality of yeast cells are recognized as kosher-for-passover.

2. The liquid mixture of claim 1, wherein the centennial hops have an alpha acidity of approximately 7.4%.

3. The liquid mixture of claim 1, wherein the Perle hops have an alpha acidity of approximately 7.2%.

4. The liquid mixture of claim 1, wherein the Saaz hops have an alpha acidity of approximately 3.8%.

5. The liquid mixture of claim 1, wherein the Hallertauer hops have an alpha acidity of approximately 3.3%.

6. The liquid mixture of claim 1, wherein the protein coagulant is Irish Moss.

7. The liquid mixture of claim 1, wherein the yeast nutrient is Yeast-X.

8. The liquid mixture of claim 1, wherein the yeast is SafAle Dried Ale Yeast S-04.

9. A liquid mixture for producing a substantially gluten-free beer between four and six percent alcohol by volume in conformity with Jewish Orthodox Law comprising:
a base, wherein the base is filtered water;
at least two sugars, wherein the two sugars are honey and molasses;
a bittering agent, wherein the bittering agent is obtained from a plurality of hops, and wherein the hops are obtained from the group consisting of Centennial hops, Perle hops, Saaz hops, and Hallertauer hops;
a protein coagulant;
a yeast nutrient;
a plurality of yeast cells; and
Wherein the base, the sugars, the bittering agent, the protein coagulant, the yeast nutrient, and the plurality of yeast cells are recognized as kosher-for-passover.

10. The liquid mixture of claim 9, wherein the centennial hops have an alpha acidity of approximately 7.4%.

11. The liquid mixture of claim 9, wherein the Perle hops have an alpha acidity of approximately 7.2%.

12. The liquid mixture of claim 9, wherein the Saaz hops have an alpha acidity of approximately 3.8%.

13. The liquid mixture of claim 9, wherein the Hallertauer hops have an alpha acidity of approximately 3.3%.

14. The liquid mixture of claim 9, wherein the protein coagulant is Irish Moss.

15. The liquid mixture of claim 9, wherein the yeast nutrient is Yeast-X.

16. The liquid mixture of claim 9, wherein the yeast is SafAle Dried Ale Yeast S-04.

17. A liquid mixture for producing a substantially gluten-free beer in conformity with Jewish Orthodox Law comprising:
a base, wherein the base is filtered water;
at least one sugar, wherein the sugar is honey;
a bittering agent, wherein the bittering agent is obtained from at least one type of hop;
a protein coagulant;
a yeast nutrient;
a plurality of yeast cells; and
Wherein the base, the sugar, the bittering agent, the protein coagulant, the yeast nutrient, and the plurality of yeast cells are recognized as kosher-for-Passover.
